(19) United States
(12) Patent Application Publication
(10) Pub. No.: US 2014/0069287 A1
(43) Pub. Date: Mar. 13, 2014

(54) PAD PRINTING SYSTEM AND METHOD THEREFOR

(71) Applicants: Laurent De Volder, Aalter (BE); Filip Feyaerts, Wetteren (BE)

(72) Inventors: Laurent De Volder, Aalter (BE); Filip Feyaerts, Wetteren (BE)

(21) Appl. No.: 14/118,468

(22) PCT Filed: May 16, 2012
(86) PCT No.: PCT/BE2012/000025

§ 371 Date: Nov. 18, 2013

(30) Foreign Application Priority Data
May 16, 2011 (BE) 2011/0296

(51) Int. Cl. B41F 17/00

(52) U.S. Cl. CPC B41F 17/001
USPC 101/333; 101/483

(57) ABSTRACT

This invention relates to a printing device of products (5) through an intermediate carrier (20), in particular of the pad (4) type, which is remarkable in that it consists of a combined intermediate support, respectively pad printing system for printing objects of the type including control surfaces, consisting of a pad based transfer system for transferring media via pad, with the endless belt, and a method therefor.

### FIELD OF THE INVENTION

The present invention relates to a combined transfer printing system for printing objects, inter alia, of the ruled surfaces type, consisting of a pad-based transfer system for ink, varnish, glue, conducting paste, thermoplastics or other mediums which are to be transferred via pad, wherein the transfer quality of traditional linear pad printing is obtained, but with the capacity, in particular speed, of rotary pad printing, or offset printing. In particular, there is transfer of medium to product without slip, in particular deformation as a result of this slip.

### BACKGROUND OF THE INVENTION

In traditional linear pad printing, the inking is obtained by a to and fro motion of the printing plate, wherein ink is left in the engraving. The ink is then taken up by a pad or similar. In a final phase, the image is deposited onto the product. An alternative method consists in the printing plate being rotated about an axis perpendicular to the plane of the flat printing plate. In both cases, the inking and the take-up of the ink takes place in a different motional state of the printing plate, namely in motion for the inking and at absolute standstill during take-up of the ink.

In rotary systems, inking is carried out continuously and ink is continuously taken up by an inked engraved roller and continuously deposited—the actual printing—onto the product(s). As a result of the rotary nature of the motion during take-up and depositing of the ink, in the case of non-developable so-called ruled surfaces, a form of slip inevitably occurs between pad roller and printing plate and/or pad roller and product. This does not benefit the print quality, so that, inter alia, four-colour printing is difficult or even impossible, due to the photorealistic quality.

The present description leans closely on these existing technologies, namely traditional linear pad printing; rotary printing, wherein a cylindrical printing roller is permanently inked and wherein a cylindrical pad roller takes up the image from the printing plate and then rolls down the product; and, finally, the indexed inking system, wherein movement and standstill of at least a part of the inking system each have a function within the cycle, via a so-called endless ink carrier such as a flat disc, and an indexed take-up and depositing of the ink.

### PRIOR ART

In traditional linear pad printing as illustrated by FIG. 1, the working principle is as follows: a pad takes up ink from a printing plate at position A by movement along an axis. For take-up of the image by the pad, the printing plate is inked, wherein the doctoring motion of the ink reservoir with doctoring system that leaves ink in the engraving takes place perpendicular to the axis. Following take-up of the image, the pad is brought into a fixed position B with respect to the product. The desired image is deposited via the pad onto the object to be printed, by movement along the axis. Following the depositing of the image onto the product, the pad is optionally cleaned with the aid of a pad wiping system: to this end, the pad is brought by movement along the axis into contact with the cleaning tape, whereupon the ink left on the pad is removed.

This system of pad printing offers a limited speed as a result of the decoupling of inking, with movement along an axis 8, and take-up of an image 4, by movement along an axis 7a, on the printing plate 2, and depositing, by movement along an axis 7b, of the ink onto the product 3. This limitation can partially be negated by simultaneously taking up ink from the printing plate and depositing it on the product, by means of extra movements and the pad. In any event, the limitation of take-up and depositing immobility during doctoring motion persists, resulting in the inherent speed limitation.

In traditional rotary pad printing as illustrated by FIG. 2, the working principle is as follows: a pad roller 1, rotating about its axis according to a rotary motion 7, takes ink 4 at fixed positions A from a printing roller 2 which rotates about its axis, lying parallel to the axis about which the pad roller rotates, according to a rotary motion 8. The printing roller 2 rotates in synchronization with the pad roller 1, such that the momentary speeds of the peripheries of the printing plate 2 and pad roller 1 are equal. Following the depositing of the image onto the product 3, the pad 1 is optionally cleaned with the aid of a pad wiping system 6: to this end, the pad 1 is dampened with ink or a liquid cleaning agent and subsequently scraped, whereupon all the liquid left on the pad is removed. Though this system offers high capacities, in particular printing speeds, it also offers lower print quality through the effect of slip. The degree of slip is influenced by a combination of factors, such as the size of the printing, geometry and surface properties of the print surface, the movement of the product, etc. There is also a limitation as regards possible shapes.

In an indexed inking system using an endless ink carrier and an indexed take-up and depositing of the ink as illustrated by FIG. 3, the working principle is analogous to the linear pad printing system, with the difference that ink is applied to the image carrier by a rotary motion 8 of the printing plate 2 about an axis parallel with the axis of take-up and depositing of the ink 7a and 7b, and thus perpendicular to the surface of the image carrier 2. The printing system can be set up both horizontally and vertically by means of the precise facilities for guaranteed inking. This system of pad printing, too, offers limited speed, as a result of the decoupling of take-up of ink 4 onto the printing plate 2 and depositing of the ink onto the product 3.

It is clear from the above that the prior art has problems and deficiencies, including in connection with the capacity, in particular speed, in relation to print quality. None of the previous systems combine high print quality, in particular photorealistic print quality, with high capacity, in particular speed. This is a problem inherent to the existing technologies, and is present under all possible conditions. Either a high print quality is achieved for all surfaces and geometries, subject to the necessary know-how, in which case, however, there are so-called dead times in the printing process, in other words inertia, or there are no dead times in the printing process but loss of quality, in particular owing to the presence of slip, in the printing, insofar as the surface is to be printed via rotary motion. Only simple geometries can be printed via rotary printing.

In each of these cases, moreover, the doctoring speed is limited. The reference value for traditional linear pad printing is deemed to be 4000 cycles/h, and for traditional rotary pad printing 25 to 40 m/min.

In terms of geometries, especially simple as opposed to complex geometries, virtually any geometry can be printed via linear pad printing, subject to the necessary know-how. This relates to both convex and slightly concave surfaces which can be printed in one or more printing steps. However, where printing consisting in depositing the image onto the product is carried out via rolling, wherein, for example, pad roller and product move relative to each other with a rotary motion, then this is virtually impossible for surfaces which are not developable ruled surfaces. This is a serious limitation with regard to the usability of this technology.

Finally, reference is also made here to pad printing systems comprising a particular doctoring system, in particular with double doctor blade.

Remedying to the above-stated limitations implies a technological solution which is not achieved by devices implementing the traditional method of pad printing.

### AIM OF THE INVENTION

The object consists in avoiding these drawbacks and rectifying them. To this end, one or more of the following measures should be taken as the solution to the problems and deficiencies of the current systems, in dependence on a number of specific parameters.

### SUMMARY OF THE INVENTION

There is thus proposed according to the invention an adapted printing system is, as defined below in the main claim, wherein the postulated object is achieved by means of an adapted device thanks to the invention, wherein the advantages of both technologies are combined in a remarkable manner, namely a continuous printing process comprising inking, image take-up and image depositing, the printing plate being continuously in motion, on the one hand, and offering a high printing quality with, inter alia, the prospect of four-colour printing, on the other hand.

An application which can be adopted as reference is the printing of caps for bottles or other containers in one or more colours, both on the essentially flat top surface and on the essentially cylindrical side edge of the cap: according to a preferred embodiment of the invention, it is possible to obtain, with the quality of linear pad printing, a speed of 40,000, 80,000, 120,000 or even more printed caps per hour, both for top printing and periphery printing of the caps, with a photorealistic print quality. Besides this application, there are also a number of other applications according to the same invention.

For the sake of simplicity, reference is hereinafter made only to inking, which should also be understood, however, as the application of other mediums, such as varnish, glue, conducting paste, thermoplastics, etc.

According to a remarkable embodiment of the invention, use is made of a continuous inking system realized as an endless belt onto/into which the images have been applied and from on which or from out of which, via a synchronized motion, the ink is taken up, and wherein this ink is then, via a synchronized motion with the moving product, deposited onto the product at the place where it needs to be applied, which thus provides the necessary freedom.

According to a further embodiment of the invention, use is made of a continuous inking system realized as a revolving flat disc with the images applied into or onto the material, from out of which or from on which, via a synchronized motion, the ink is taken up, and wherein this ink is then, via a synchronized motion with the moving product, deposited onto the product at the place where it needs to be applied.

A particular embodiment of the invention consists in that the ink is selectively applied onto or into microscopic recesses in the revolving carrier, with formation of an image via a traditional closed inking system as used in traditional pad printing.

An alternative embodiment of the invention consists in that the ink is selectively applied onto or into microscopic recesses in the revolving carrier, as in each of the previous embodiments, but with formation of an image via a digital printing process.

These cited embodiments indicate the core of the invention: continuous motion of the image carrier, with printing of an image to be applied to the product by means of a printing medium such as ink, but also varnish, glue, conducting paste, thermoplastics, etc, during the motion, and continuous motion (synchronized with the previous motion) of a pad-based image transfer system, and continuous motion (synchronized with the previous motion) of the product(s) to be printed. Thus, by virtue of the combined system as proposed according to the invention, both a high speed and a qualitative transfer are obtained. Moreover, a very good positioning of the products is achieved.

The present invention further relates to a method for pad-based printing of the abovementioned goods, in particular a device according to this invention. The method according to the invention thus meets important parameters. As a result of this method, optimal printing is obtained, specific characteristics of which are defined in the related subclaims. The measures proposed according to the invention which constitute the solution to the problems and deficiencies of the current methods are set out below with reference to the finding that the pad printing method is founded on changes in surface tension during the various steps: inking of the ink carrier, take-up of the ink from the ink carrier, in particular the printing plate, by means of an intermediate carrier, in particular a pad, and depositing of the ink from the pad onto/to the product. This applies, as the case may be, to any system for transferring ink by means of a temporary carrier of the ink, in particular a pad or pad roller. This also applies to any other form of transfer of a printing medium such as varnish, glue, conducting paste, thermoplastics and the like.

In case of linear motion perpendicular to an ink carrier, in particular a printing plate, during take-up of the ink to guarantee the quality of the printing, the pad should move perpendicularly to the ink carrier or printing plate during the ink take-up. The displacement length is, inter alia, dependent on the pad, especially the shape, hardness and the like, and the size of the image. The method of take-up of ink from the ink carrier can be extended, moreover, by a delay time between inking and the effective take-up of the ink, during which evaporation of an element in the ink, in particular solvents, occurs. This delay time can be necessary in the take-up method for the ink. This motion of ink take-up from the ink carrier should take place simultaneously with all other motions in the printing method, such as the inking of the carrier, the displacement of the pad to the desired printing position—or equivalently the movement of the product to the desired product position—and the depositing of the ink from the pad onto/to the product.

An adapted motion of the pad takes place with respect to the product during depositing of the ink to guarantee the quality of the printing. With a linear motion perpendicular to the product during depositing of the ink to guarantee the quality of the printing, for traditional linear pad-based printing the pad should move perpendicularly to the product during the ink depositing. The displacement length is, inter alia, dependent on the pad, but also on the geometry of the surface of the product, or else other surface properties of the product and the size of the image.

With a rotary motion with respect to developable ruled surfaces during depositing of the ink to guarantee the quality of the printing, for traditional rotary pad-based printing the pad should roll down the ruled surface of the product as the ink is deposited. The rolling length is dependent on a combination of the size of the printing, the choice of the pad and the geometry of the product.

According to the main embodiment of the invention, the motion of the product—linear and rotary motion—should be adapted, given that the average person skilled in the art will not combine linear and rotary printing in a continuous manner. This can be realized in two ways, which are to be regarded as equivalent, the first of which consists in the use of a pad having a developable ruled surface, in particular a cylindrical pad or a segment thereof. This can also be done using a pad which is not a developable ruled surface. It is clear that the motion of the endless belts to which products and/or pads are fastened, the relative motion of products and/or pads, should be compensated, with due regard to the one-to-one relationship between pad and product with regard to the sequence of printing. In particular, the image on the pad can be deposited onto a (its) product only once per cycle.

The method of depositing the ink from the pad can in both cases, moreover, be extended by a delay time between take-up of the ink and the effective depositing of the ink. During this delay time, evaporation of elements in the ink, in particular solvents, occurs. This delay time can be necessary in the depositing method for the ink.

This ink-depositing motion of the temporary ink carrier, in particular the pad, should take place simultaneously with all other motions in the printing method, such as inking of the carrier, take-up of ink from the ink carrier to the said temporary ink carrier, and the displacement of the pad to the desired printing position, or equivalently the movement of the product to the desired product position.

In order to eliminate all dead times in the printing process, all phases are carried out simultaneously and without discontinuities. To this end, use is made of a system based on an endless belt which moves continuously, preferably at constant speed. As a result, dead times which are found in traditional pad printing systems are, however, eliminated thanks to the present invention.

Further advantages of the invention over existing systems are described below: complex surfaces, both convex and slightly concave, can be printed in photorealistic quality at speeds which far exceed the traditional speeds in pad printing.

The necessary flexibility in terms of the adjustment of the parameters to be set with respect to the printing process, such as displacement lengths of the pad in the take-up and depositing of the image, delay times for take-up and for depositing etc., is present in all embodiments.

An additional advantage is ease of use. The described device allows simple changing of ink, ink carrier, in particular printing plate, print images, in particular on the ink carrier, pads.

A first embodiment comprises, indeed, a closed ink system, the advantages and simplicity of which for the purpose of topping up and changing are known.

Another embodiment, using a digital inking system, allows unprecedented flexibility in terms of the image; in particular, changes of print image during production lie within the realms of feasibility.

Further features and properties of the invention are defined in the appended subclaims, in particular 20 to 29, resp. 48 and following, with regard to an additional contrivance, the remarkable elements of which are explained in greater detail below. It has been established, of course, that there are some problems, primarily doctoring problems, in connection with the used printing plate. In order to rectify this, a second pot has been mounted, namely a pot of ink and a pot of solvent which ensures that the ink does not dry out. In view of the fact that it all revolves so quickly, it was assumed a priori that there would be no problem. In reality, however, this turned out to present a problem, to which the following solution is proposed, which solution consists in the adoption of an innovative doctoring system which is to be placed on the pad printing machine according to the invention, wherein the intention was to adhere to a round printing plate on which stands an inkpot, where now, according to the invention, recourse has been made to a remarkable system of magnets. These define the impression force or the force with which the pot is pressed against the printing plate, whereas this was hitherto realized via the force of a ram. This is the first element of the additional contrivance.

The second element is that a second pot is provided, also in interaction with the said magnets and under the influence thereof. In the place where pressure is applied to the side edge, the second pot is pressed in the centre with a pin-type holder and held in place. It is thus merely held in place without any significant pressure being applied here, in contrast to the earlier system in which real pressure has to be applied in order to be able to conduct the doctoring operation. The same applies to the second, added inkpot, where solvent, and if appropriate ink, is introduced, intended for doctoring purposes in order to ensure that what is found on the printing plate does not dry in on the plate. It is thus possible to operate in two ways, either respectively with ink, or with ink in one pot and solvent in the other, bearing in mind, however, that ink cleans less well and, inter alia, pharmaceutical inks dry very quickly, so that in that case, however, a build-up is formed. The least build-up occurs if solvents, in particular an edible alcohol, are used.

Added to this, however, is the fact that if this is done only with solvents, a very high concentration of solvents is found in the engraving, whereby the ink which in this case ends up in the image is too light and has insufficient pigment when the image passes back under the inkpot, thus resulting in qualitatively unsatisfactory printing. On the other hand, the realization of a constant wetting of the printing plate is ensured, especially by way of a second pot, and directly after this is placed a doctor blade, which ensures that everything which is not in the engraving but on top of the printing plate is held against here. Directly afterwards, air-blowing is carried out, in such a way that whatever is still present in the engraving proceeds to evaporate under the influence thereof. The result is that no belt can thus be obtained here, whereupon a build-up is formed wherever the printing plate passes, owing to the intrinsic incompleteness of the doctoring. Here this adverse effect of build-up is countered, however, because the moisture is maintained and there is no excess of solvents in the engraving.

As opposed to a traditional system in which a pot is mechanically clamped onto the printing plate, here priority is thus given to holding this in place by means of magnets, such that no downward impression force is exerted, but instead an upward force from the pot upwards. The printing plate hereupon lies firmly on the bottom plate, which remains very flat and horizontal by virtue of the magnets. Thus a keyway, a round hole and a slotted hole, is seated therein, so that the printing plate can be inserted there relatively accurately. This then remains fixed by means of a number of magnets, which hold the plate in place. If, in the doctoring process, very hard pressure is applied there, mechanical instability is created there by the fact that it is a disc which is mounted and sits supported on its axis, so that every effort is made to reduce this force from the pressing hereon as much as possible. Experimentally, a doctor blade C was installed, and also an air knife D. A pot was then additionally put in place and tests were conducted only with air and this pot, whereupon it was established that a build-up was still formed once again, so that the proposal was then eventually made to include there an extra doctoring system B, wherein a particular doctoring chamber was used, given that the force of the doctoring is much smaller. With an ordinary pot, after all, a relatively large amount of force must be deployed. This then forms a subtle solution to the cited build-up problem with the ink system per se. The additional, second pot has a different function from the first.

The system according to the invention uses a round printing plate, yet not in a continuous motion but in an indexing motion, wherein at any one moment the image is present in two places, which each time rotate through 180°. This image is thus inked by the pot and ends up in the appropriate position and then the pads are suitably taken up and also rotated once again through 180°. The reason for having this added is drying-in. If the ink is not removed from the engraving, then a build-up, consisting of hardened ink, is formed, of course, at the margin. Since rotation is always effected in the same direction, at a certain moment pieces can detach therefrom, which shoot under the doctor blade and then land in the inkpot, resulting in printing problems. That must be limited, as far as possible, by regularly cleaning and preventing the build-up of layers, subject to the innovation being added, which greatly reduces this unwanted build-up.

A further problem can arise in connection with the changing of such a printing plate, for example because it is worn, and a new one has to be installed, or because a new ink mixture or a different ink colour is going to have to be used, which means that this pot must be removed, with the result that the whole of that system must be removed. If the machine has to start and stop, there is a set procedure in which account will have to be taken of the fact that, if it has stopped, then it is the intention for this type of continuous machine, in which high printing speed is a crucial factor, that the interruption should remain as short as possible, due to profitability reasons. For this, it was provided to slide the pot inwards. An additional reason for reducing the pressure as much as possible is the doctoring itself, wearing of the printing plate and of the doctor blade, mechanical instability, warming of the printing plate, and thus the drying problems and the drying-in problems with the ink. Where doctoring is carried out, ink is taken up onto a very large part of the circle. The intention is that if etching inadvertently occurs in the printing plate, then it should happen at a place where no image was present. It is hence very important that if the production has to be stopped, these pots are effectively shifted, and the pot is slid inwards. That is solved by not stopping too often and regularly wiping, which in this machine is much more critical: the problem has grown, of course, because it runs much faster. Consequently, it is very important that the pressure is kept as low as possible here. After all, the harder the pressing, the faster it moves, the warmer it becomes, and the greater the effect of warming, and thus drying-out, of the ink. Thus, there must be as little pressure as possible here, yet sufficient pressure that the doctoring remains fine.

Provided that a suitable inkpot is used, the pressure is kept as low as possible by virtue of the fact that the magnets draw the printing plate, as it were, upwards. It is thus necessary not to press too hard, so that consequently no mechanical problem arises. The second pot thus has advantages.

The same effect is obtained via the double doctor blade, in particular the one as described, to which reference is expressly made here. This is a system, of course, with strikingly little impression force and very low doctoring force.

In other words, one must be sure that no ink can be left in this engraving if the machine, whose steady state is continuous operation, must start and stop. It is then necessary to stop inking. If inking in this continuous machine has to be halted, then the pot must be slid inwards: this then no longer goes on inking and it can then either continue to rotate, in which case the solvent is used to keep everything sufficiently wet, or can be completely stopped.

Further details and particularities of the invention are set out with reference to the following description of an illustrative embodiment of the device, or method of the invention for both these last, with the aid of the appended drawings, in which the same reference numerals relate to the same or analogous elements.

### BRIEF DESCRIPTION OF THE DRAWINGS

FIG. 1 set out above is a basic diagram of a classical linear pad priniting system.

FIG. 2 set out above as well shows a further basic diagram of a classical rotary pad priniting system.

FIG. 3 equally set out above is a still further basic diagram, yet of an indexed linear pad priniting system with a cliché rotating about an axis being parallel to an ink taking-up resp. depositing axis by means of a pad.

FIGS. 4 and 5 each show basic diagrams of an implementation of the invention with rotating disc and with endless belt respectively.

FIG. 6 shows a basic diagram of an additional contrivence of the invention.

FIG. 7 etc. illustrate schematically the various phases of the inking of a printing plate in a method and device comprising possible embodiments of doctor blades according to the invention.

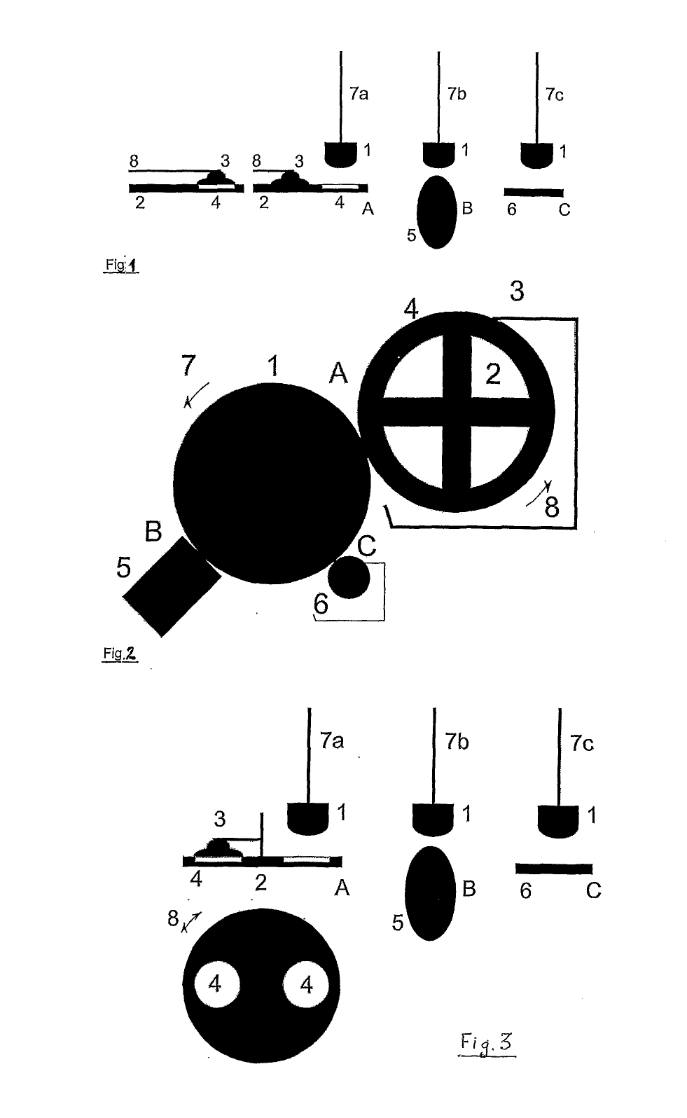

### DESCRIPTION

In general terms, the present invention relates to a system, inter alia having 1 colour of printing medium such as ink, or else varnish, glue, conducting paste, thermoplastics, etc., comprising an endless belt for inking; continuous motion; closed ink system, and an endless belt bearing pads, likewise an endless belt bearing products.

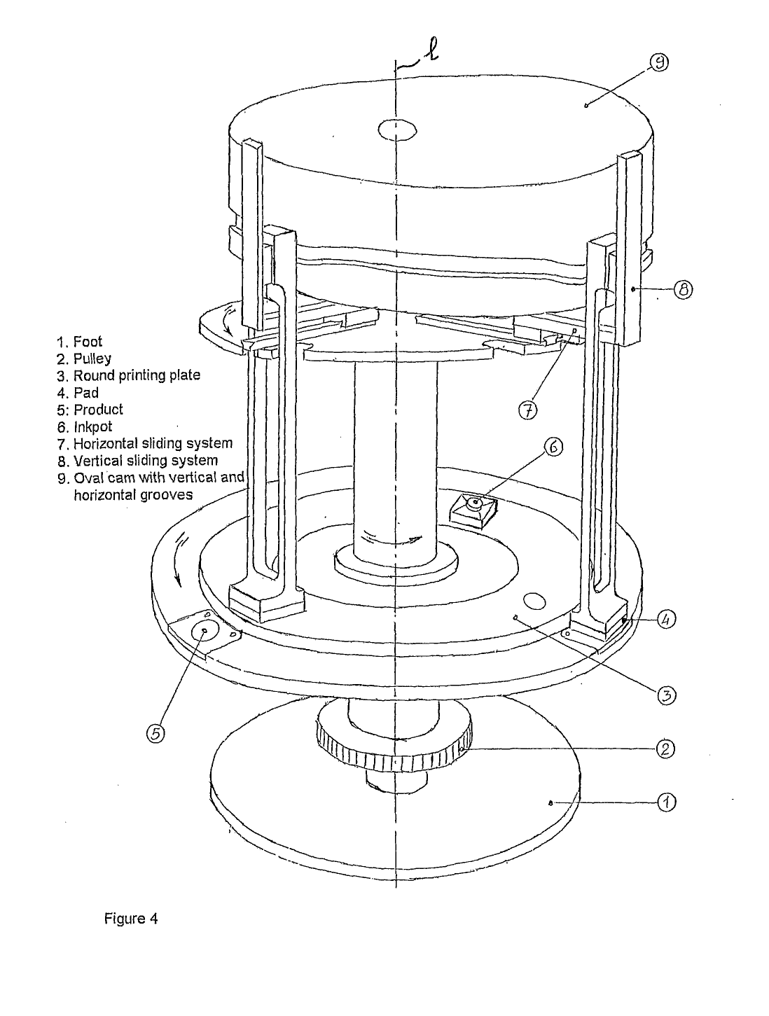

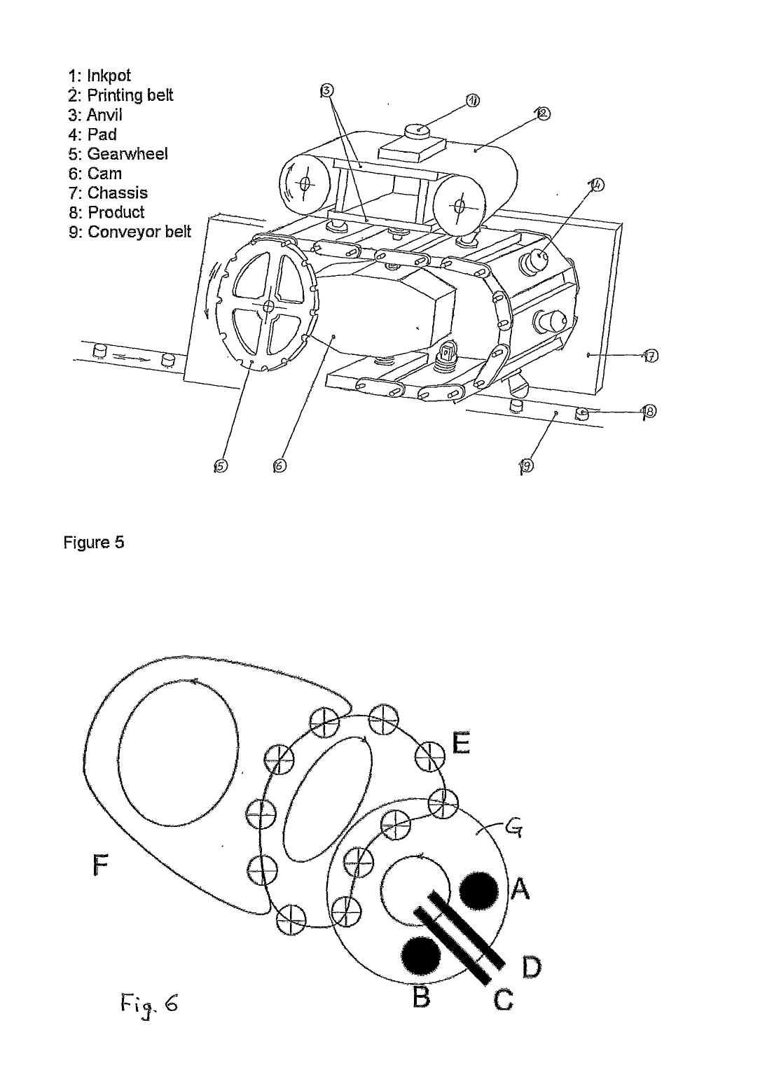

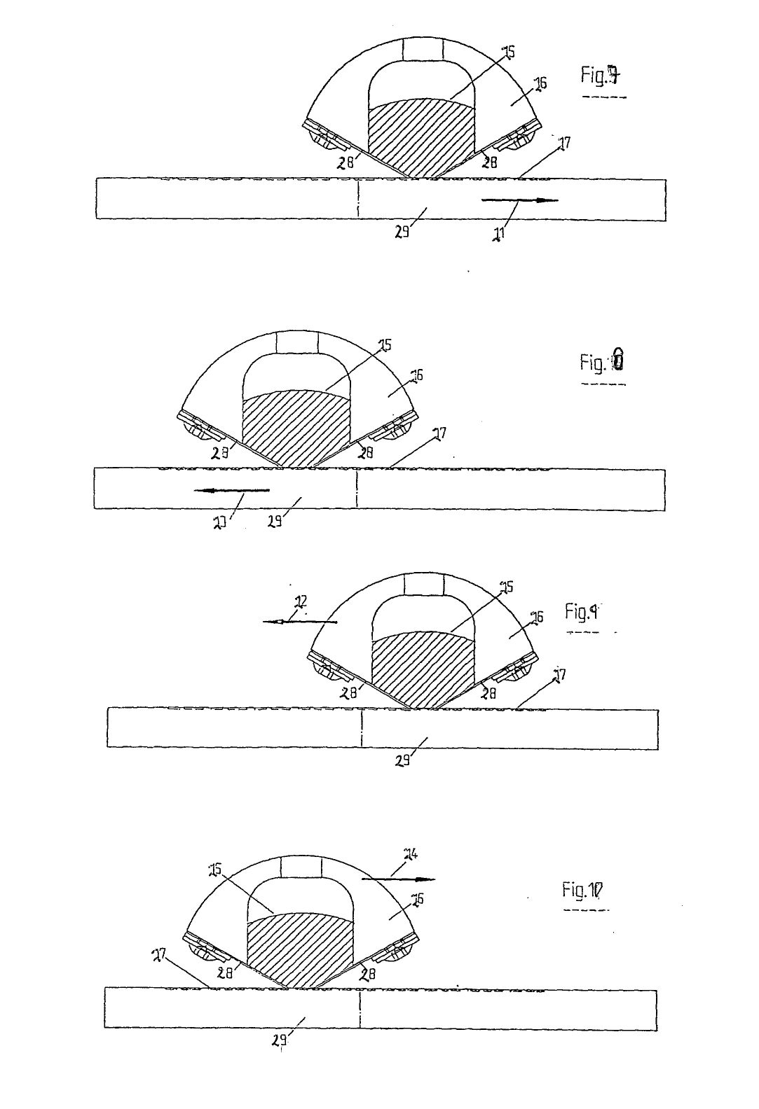

FIG. 4 represents a system having a plurality of colours, especially ink, varnish, glue, conducting paste, thermoplastics and the like, for which various alternatives have been devised. In a first embodiment, a plurality of single-colour systems are placed one after another. The products 5 here need to be correctly positioned during the application of the various colours.

In another embodiment, the images for the various colours are placed on the same endless belt 20 in such a way that the images stand side by side when viewed in the motional direction of the endless belt. The inking systems are consequently placed side by side such that, during the motion of the belt, a trail of images per colour, as it were, is obtained. Use is made here of pads 14, which are positioned with respect to these various trails. There is no fundamental difference between embodiments in which the pads are displaceable in the transverse direction, those in which the products are displaceable in the transverse direction, or those having a combination of transverse displacement of pads and products.

The most important thing is that, during the depositing of the image onto the product, the pads 14 are correctly positioned with respect to the product 18. As a result, printing in several colours on several positions of the product is possible. This method results in a reduction of the printing speed, since the images are taken up and deposited one after another. The abovementioned advantages over traditional and rotary pad printing are nevertheless maintained.

With an endless belt for inking, images are placed on the endless belt for a particular embodiment at predefined places. To enable the images to be correctly positioned with respect to the pads and the products with each revolution, it is necessary for the endless belts to move in a zone-synchronous manner: zone image on the printing plate synchronous with zone pad, synchronous with zone product. To this end, traditional electromechanical techniques can be used.

With an endless belt of pads, pads can assume different shapes.

Traditionally, in the case of pad printing, a predefined image is taken up from the printing plate and transferred to the product. It is also possible, however, that the pad, for example consisting of an inked solid, selectively takes up the image to be printed: indirect gravure printing. An embodiment of this limit case also falls under the protection of the invention.

FIG. 4 shows a basic diagram with rotating disc based on an endless belt in the form of a round disc. A circular printing plate 3 is inked, by rotation about the principal axis l, by means of a fixedly mounted inkpot 6. Products 5 and pads 4 are synchronized in rotation about the same principal axis l by a physical coupling. The vertical take-up motion of the pads 4 is obtained by the movement of a reference point from the pads via a cam system into a cam 9, for example oval with vertical and horizontal grooves. During the cycle of a rotation about the principal axis I, both the vertical motion—down and up—for take-up of the image on the printing plate 3, and the vertical motion for the depositing of the image onto the product 5 are realized. The products 5 move along a circular path concentric with the printing plate 3 along the principal axis I. In order both to take up the image from the printing plate 3 and deposit the received image onto the product 5 with the same pad 4, the pad must be able to move to and fro between the 2 concentric paths. The horizontal motion, with horizontal sliding system 7 for the same, is obtained by movement of a reference point from the pad via a cam system into the cam 9. Within the cycle of 1 rotation, the product 5 must be placed onto the concentric path and removed again.

FIG. 5 shows an endless belt in the form of a conveyor belt. A printing plate 12 realized as a conveyor belt is inked, by rotation of the conveyor belt, by means of a fixedly mounted inkpot 11. Products 18 and pads 14 are synchronized through the engagement of the gearwheel 15 in the product-conveyor belt 19. The vertical motion of the pads during take-up and depositing of the image is obtained by moving a reference point from the pads along a cam system into a cam 16. During the cycle of a rotation of the conveyor belt 19, both the vertical motion—down and up—for take-up of the image onto the printing plate 13 and the vertical motion for the depositing of the image onto the product are realized. The products 18 move along a linear path parallel with the pads. The product 18 must be placed onto the conveyor belt 19 and removed again, preferably outside of the zone for the depositing of the image.

The working of the system is described below in its 4 phases.

In phase 1, of inking, the endless belt is continuously inked. A number of embodiments are differentiated:

the endless and continuously rotating belt is continuously inked via a traditional open or closed ink system known from pad printing; the images are applied into the belt as a recess in which the ink can be left during the doctoring process, and these are located at predefined places on the endless belt; these images are applied by means of a method outside of the production process, especially the printing.

The endless and continuously rotating belt is continuously inked via a traditional open or closed ink system known from pad printing; the images are applied into the belt as a recess in which the ink can be left during the doctoring process, and these are located at predefined places on the endless belt; these images are applied during the production process for inking and printing with an, as it were, digital image generation system.

The endless belt is inked via a digital ink system, which during its continuous motion applies the ink to the predefined places; over its total length or limited to predefined zones, the belt is construed as a carrier, to which ink can temporarily be applied and from which the ink can be taken up and transferred to a temporary intermediate carrier or, where appropriate, even the product.

Phase 2 is that of ink take-up, wherein the endless belt is continuously inked with images as described in the above. In traditional linear printing, the linear axis 7a of a pad is then moved in synchronization with the image to be transferred. To this end, the pad(s) is/are fastened to a second endless belt, which is moved in synchronization with the first ink carrier. During this motion, the pad is moved according to a linear movement along the axis 7a, whereupon the image is taken up onto the temporary carrier, in particular the pad. During this motion, the relative motion of the pad with respect to the ink carrier is purely linear.

In traditional rotary printing, the pad is then moved in synchronization with the image to be transferred. To this end, the pad(s) is/are fastened to a second endless belt, which is moved in synchronization with the first ink carrier. Two cases can arise: involving the use of a pad having a developable ruled surface, in particular a cylindrical pad or a segment thereof; the speed of the endless belt to which the pad(s) is/are fastened is necessarily less than the doctoring speed of the endless ink carrier, taking account of the relative motion of the pad about its rotational axis, transversely to the doctoring direction. Or involving the use of a pad which is not a developable ruled surface; the method of take-up of the ink is analogous to the process in the case of traditional linear printing as described earlier.

Phase 3 is that of positioning of the pad with respect to the product: following take-up of the image according to the preceding description, each pad is transported according to the endless belt, which positions the pad(s) in a synchronized manner with respect to the product(s) which is/are mounted on a third endless belt. Here, account must also be taken of the positioning of the pad with respect to the product in the motional direction of the endless belt on which the products are connected, in the transverse direction hereto and in rotation. In particular, it is also possible to apply prints in several colours to different places on the product.

Phase 4 is that of ink depositing. In traditional linear printing, the motions of the endless belts of pads and products are synchronized such that, in the event of movement along the axis 7a, the resulting relative motion between pad and product is purely linear.

In traditional rotary printing, two cases can arise: involving the use of a pad having a developable ruled surface, in particular a cylindrical pad or a segment thereof; the speed of the endless belt to which each pad is fastened can be less than the speed of the endless belt bearing the products, taking account of the relative motion of the pad about its rotational axis, transversely to the doctoring direction. Or involving the use of a pad which is not a developable ruled surface; the method of depositing of the ink is analogous to the process in the case of traditional linear printing as described earlier.

The cycle according to the said phases occurs in parallel for the various pads and products to be printed.

Here, the focus has been on the printing of complex convex and concave objects. It should be clearly understood, however, that not only complex, but also simple surfaces, such as developable ruled surfaces including cylinders, cones and the like can be printed with this technology. Examples are the top and the periphery of caps of bottles or other containers, such as syringes. According to one embodiment, the top and periphery of such caps could be printed at high speed with high-value photorealistic images with one and the same machine.

FIG. 6 shows the additional innovation consisting, inter alia, of the following elements: an ink system A, a cleaning doctoring system B with the aid of ink or cleaning product, especially solvent, a doctor blade C, an air knife D, pads on a guide E and product on a product transport system F. With regard to the industrializability of the device, the following is of primary importance: quality of the printing and repetitivity and continuity of the quality of the printing in an industrial environment. The quality of the printing is dependent on a number of factors, including the system of inking and the system of transfer.

In the case of inking via a doctoring system with closed chamber, it is ensured that the doctoring involves an only limited impression force on the printing plate. High impression force of the closed ink system on the printing plate produces, after all, large friction forces which negatively influence the mechanical strength and stability and the required drive. In addition, with increasing friction force and increasing doctoring speed, the heat development increases, resulting possibly in additional drying-out effects, namely drying-in of ink between the images and drying-in of residual ink in the negative image.

Minimalization of the impression force is obtained, inter alia, by virtue of the remarkable use of magnets in the doctoring system, whereby the printing plate is drawn partially towards the doctoring system for printing plates with magnetic properties. The use of the double doctor blade also reduces the impression force, since a lower impression force is required relative to a traditional closed round or oval doctoring system in order to obtain the same quality of doctoring.

In order to reduce or even eliminate drying-in of the ink in or on the intermediate carrier, in particular printing plate, use is made of an integrated, though separate system which reduces or even removes undesired residues of ink from on and from out of the printing plate; the drying-in or drying-on of undesired ink is with certainty avoided to a greater extent. This is obtained by, for example, installing a second closed chamber doctoring system after the taking-up of the ink by means of the pad(s). This doctoring system, provided with the same ink or a cleaning agent, namely solvent, has several functions, including scraping off of any ink (wet or dry) which might yet still be present and is thus undesirable; general cleaning of the printing plate; re-wetting of the negative image and/or re-wetting of any ink residues between the images.

In an advantageous embodiment, this cleaning process can be replaced by a mechanical action, inter alia by brushing, or by controlled blowing out, and/or further optimized.

If an ink-compatible cleaning agent is used, it is necessary, moreover, that the excess cleaning agent which has not been taken up from the negative image is removed before ink is re-applied into this negative image or doctored. Otherwise, as a result of an excess of cleaning agent, especially solvent, insufficient ink—and thus colour pigment—would be applied into the negative image, resulting in a watery print. The removal of this excess of solvent can be realized via mechanical action, inter alia brushing, via blowing out, or even via forced, accelerated evaporation.

Care is taken to ensure that, in blowing-out or controlled evaporation, the zones between the images are made as residue-free as possible before this action. This can be done, for example, by installing an extra doctor blade between cleaning, in particular via a doctoring system with ink or solvent, and blowing-out/forced evaporation—for example with an air knife—or by installing this same extra doctor blade in advance of a new inking cycle.

A preferred embodiment also provides circulation systems for ink and/or solvent from and to the doctoring systems. This ensures that the viscosity of the ink is kept under control and that the cleaning agent, preferably solvent but also possibly ink, is kept clean. A continuous working of the inking system is hereby optimized.

The above-described cleaning of the printing plate is also, and in particular, of interest when the machine passes from production to stand-by, or even stops. After all, the presence of printing plate cleaning makes it possible to resume production without additional and time-consuming manual action by an operator owing to cleaning of the printing plate. Even if the inking system were to stop inking, then the drying-on and drying-in of residual ink would still constitute a problem with regard to quality of the printing when production is restarted.

The inking can be halted in a variety of ways. If inking is carried out digitally, the solution consists in a controlled stoppage of the inking. If, however, a closed chamber doctoring system is employed, the inking can be halted by displacing the doctoring chamber to a zone outside of the image zone. This can be done, for example, by displacing the doctoring chamber to the centre of the printing plate or by displacing the doctoring chamber away from the printing plate.

An important prospect for the proposed technology is so-called digital pad printing.

Via the system of the endless belt, any image or any product can be applied at a speed which is defined and/or limited by inking, delay times and the number of parallel systems, especially the number of pads related to the length and width of the endless belt.

1. Device for printing products via an intermediate carrier, in particular of the pad type, characterized in that it consists of a combined intermediate support, respectively pad printing system for printing objects (5, 18) notably of the rule surfaces type consisting of a pad based transmission system through (4, 14) for media to be transferred by pad, in particular with an endless belt.

2. Device according to the previous claim, characterized in that said transfer system for media to be transferred by pad, is equipped with a rotary disc on the basis of said endless belt, and in that it comprises an endless belt for inking for a one color system, notably ink, varnish, adhesive, conductive paste, thermoplastics, e.a; a continuous motion, a closed ink system, and an endless belt with pads, as well as an endless belt with products.

3. Device according to one of the preceding claims, characterized in that it consists of an indexed linear pad printing system with rotation of the cliché (3) about an axis (e) parallel to the ink take-up and deposition axis of the pad (4).

4. Device according to one of the claims 1 to 3, characterized in that for a multiple color system, it comprises several one color systems that are placed the one after the other, wherein the products are positioned correctly during the application of the different colors.

5. Device according to one of the claims 1 to 3, characterized in that the images for the different colors are arranged on one and the same endless belt (20) in such a way that the images are located side-by-side respective the motion direction of the endless belt, wherein the inking systems (11) are placed next to each other in such a way that during the motion of the belt, a track of images is set for each color, wherein there is provided a set of pads that are positioned relative to said tracks, wherein the pads (14) are movable in the transverse direction, the products (18) are movable in the transverse direction or in combination of transverse displacement of pads and products, wherein the pads (14) are positioned correctly with respect to the product (18) during the deposition of the image on the product, for the sake of printing in multiple colors on a plurality of positions of the product, and of reducibility of the printing speed, wherein the images can be picked-up and/or deposited the one after the other.

6. Device according to one of claims 1 to 5, characterized in that the images are applicable at predetermined locations on the endless belt (20) with an inking endless belt (12).

7. Device according to one of the preceding claims, characterized in that the endless belts are movable in synchronism by zone with an image zone on the cliché in synchronism with a pad zone that is in synchronism with a product zone, in particular with electromechanical means, so that for every revolution the images are positioned correctly relative to the pads and products.

8. Device according to one of the preceding claims, characterized in that in an endless belt with pads, the latter have different shapes, in particular wherein a predefined image can be taken-up from the cliché and is transferrable on the product.

9. Device according to one of claims 1 to 8, characterized in that the image to be printed is absorbable selectively by the pad, in particular from an inked solid surface, notably indirect gravure.

10. Device according to one of the preceding claims, characterized in that the rotary disc on the basis of an endless belt is in the form of a circular disc (3).

11. Device according to one of the preceding claims, characterized in that a circular cliché (3) is coatable with ink by means of an ink pot (6) which is fixedly mounted, by rotation about the main axis (l), in particular wherein products (5) and pads (6) are synchronized in rotation about the same axis (l) by a physical link.

12. Device according to one of the preceding claims, characterized in that the products (5) are movable along a circular path that is concentric with the cliché (3), along the reference axis (l).

13. Device according to one of the preceding claims, characterized in that the pad (4) is movable to and fro between the two concentric paths, so that both the image can be taken-up from the cliché (3) ànd it can be deposited on the product (5) with the same pad.

14. Device according to one of the preceding claims, characterized in that the product (5) is locatable on the concentric path and is removable therefrom again, within the cycle of one single rotation.

15. Device according to one of the preceding claims, characterized in that the endless belt is in the shape of a conveyor belt (19).

16. Device according to one of the preceding claims, characterized in that the cliché (12) is in the shape of a conveyor belt and in that it is coatable with ink by rotation of the conveyor belt (20) by means of an ink pot (11), possibly positioned in offset respective the cliché.

17. Device according to the preceding claim, characterized in that said ink pot (11) is fixedly mounted respective cliché (12).

18. Device according to one of the preceding claims, characterized in that products (8) and pads (4) are synchronizable by the action of a gear wheel (15) in the product-conveyor belt (19), in particular wherein the vertical motion of the pads (14) during image take-up and depositing is achievable by the mobility of a reference point of the pads according to a cam system in cam (16).

19. Device according to one of the preceding claims, characterized in that the products (18) are movable along a linear path in parallel with the pads (14), in particular wherein the product (18), preferably outside the image deposit zone, is locatable on the conveyor belt (19) and removable therefrom again.

20. Device according to one of the preceding claims when inking via a doctor blade system (B), especially with a closed chamber, characterized in that the doctor blade system comprises at least one set of magnets (A, . . . ) which are provided in co-operation with a cliché (G) having magnetic properties, in particular consisting of a magnetic material such as esp. of the ferromagnetic type, in such a way that the printing plate or cliché is pulled partly to the doctor blade system.

21. Device according to one of the preceding claims, characterized in that said doctor blade system comprises a double doctor blade (28) both of which are opposite each other for scraping off the ink in pad printing, when inking an engraved printing plate (29) from an ink reservoir, wherein at least the bottom edge of the one doctor blade (28) which is in contact with the printing plate, is set at a negative angle measured with respect to the inked part (27) of the printing plate to be scraped off with respect to the printing plate, and, without changing the position of the doctor blade, a relative motion (21; 23) of the doctor blade respective the printing plate is generated, in a direction to ink the printing plate on the one hand, and in the other direction to scrape the ink from the printing plate, on the other hand.

22. Device for inking a printing plate (29) and for scraping off the ink (27) in pad printing according to the previous claim, characterized in that it consists of the combination of:
a) an ink reservoir (26) for inking the printing plate (29) during a relative motion (21; 23) of the printing plate (29) with respect to this ink reservoir,
b) at least one doctor blade (28) of which the bottom edge which comes into contact with the printing plate, is set at a negative angle with respect to the printing plate, defining an angle measured with respect to the portion of the printing plate yet being inked and still to be scraped off.

23. Device according to the preceding claim, characterized in that the negative angle has a value substantially comprised between 90° and 180°, in that the doctor blade is composed of a flexible and/or non-deformable material, respectively wherein the cliché (29) is made from a rigid plate, wherein both printing plate and doctor blade are mutually displaceable, in particular in the opposite direction, and wherein one of them is held stationary, more in particular wherein the doctor blade is flat and has a lower edge, which is curved according to said negative angle and which forms an obtuse or acute angle with a doctor blade.

24. Device according to one of the claims 21 to 23, characterized in that the doctor blade has an arcuate profile, and a lower edge which extends according to said negative angle.

25. Device according to one of the claims 21 to 23, characterized in that said doctor blade is bent in the vertical direction in accordance with several sharp angles and has a lower edge which proceeds according to said negative angle, in particular in which the doctor blade forms an elongated ink gap, wherein the doctor blade and ink tank are securable on a common elongated housing (17) and/or wherein the doctor blade and said elongated housing form a whole, which can be more particularly injected moulded together from the same material, wherein yet more particularly the doctor blade forms a closed circle and a portion of the doctor blade extends according to said negative angle.

26. Device according to one of the preceding claims, characterized in that an integrated yet separate system is provided herein in such a way that undesired ink residues from the cliché are reduced so as to counter undesired ink drying, in particular in or on the cliché as intermediate carrier, more particularly by incorporation of a second doctor blade—notably with a closed chamber—after take-up of the ink by means of the pad(s), wherein it is provided with the same ink, or a cleaning agent, notably a solvent, and wherein it performs several functions, including scraping off any residual ink, either wet or dry; general cleaning of the cliché; wetting again of negative image; and moistening again of any ink residues between the images.

27. Device according to one of the preceding claims, characterized in that an additional doctor blade is provided between cleaning—via the doctor blade system with ink or solvent- and blowing out/forced evaporating, in particular by means of an air knife (D), or by placing this same additional doctor blade prior to a new inking cycle, in order to make the areas between the images residual free for this action when blowing out or controlled evaporating.

28. Device according to one of the preceding claims, characterized in that ink and/or solvent circulation systems to and from the doctoring systems are provided, in order to keep the ink viscosity under control and wherein the cleaning agent—in particular solvent—is kept unaltered, for the sake of a continuous operation of the inking system.

29. Device according to one of the preceding claims, characterized by the presence therein of a cliché cleaning system by virtue whereof the production can be resumed without any additional manual operation by a cleaning operator of the cliché.

30. Method for printing objects, notably of the type including rule surfaces, via an intermediate carrier, in particular of the pad type (4, 14, E), more particularly with a device or system according to any one of the preceding claims, characterized in that a combined intermediate carrier system, in particular a pad printing system, is operated for printing objects (5, 18, F), wherein a printing medium such as ink, varnish, adhesive, conductive paste, thermoplastics, and others, is transferred to the object (5, 18, F) via an intermediate carrier, in particular pad (4, 14, E), by performing a combined linear and rotary intermediate printing, in particular resp. pad printing, wherein the transfer quality of linear pad printing is achieved, yet with the capacity, in particular speed, of rotary pad printing or offset, wherein the transfer of medium operates without slip, in particular deformation as a result of this slip.

31. Method according to the preceding claim, characterized in that an endless belt is inked under a continuous motion in a closed ink system (A), in particular an endless belt with pads (E), and an endless belt with products (F) as well, especially with one color.

32. Method according to claim 30, characterized in that the cliché (3) is rotated about an axis (t) parallel to the pad (4) taking-up resp. depositing axis of the ink by means of an indexed linear pad printing system with a rotating disc (3).

33. Method according to one of the claim 30 or 31 for printing with multiple colors, characterized in that several one color systems are placed successively, wherein the products are positioned suitably during the application of the different colors.

34. Method according to one of the claim 30, 31 or 33, wherein the images for the different colors are applied on one same endless belt in such a way that the images are side by side with respect to the motion direction of the endless belt (20), wherein the inking systems (11) are thus placed next to each other as well, in such a way that during the motion of the tape a track of images per color is carried out, in particular wherein use is made of pads (14) which are positioned with respect to these different tracks.

35. Method according to one of the claims 30 to 34, characterized in that the pads are moved in the transverse direction, or resp. in that the products are moved in the transverse direction, or wherein a combination of transverse displacement of pads and products is performed, in particular wherein the pads are positioned correctly relative to the product during the deposition of the image on the product, resulting in printing in multiple colors on a plurality of positions of the product is achieved.

36. Method according to one of the claims 30 to 35, characterized in that the images are picked up and/or deposited the one after the other, wherein the printing speed is reduced.

37. Method according to one of the claims 30 to 36, characterized in that images are applied to the endless belt (20) at predetermined locations with an inking endless belt (12).

38. Method according to one of the claims 30 to 37, characterized in that the endless belts are moved in synchronism by zones, wherein an image zone on the cliché is adjusted in synchronism with a pad zone, in synchronism with a product zone, so that for each revolution the images are positioned correctly with respect to the pads and the products.

39. Method according to one of the claims 30 to 38, characterized in that pads of different shapes are operated with the endless pad belt, in particular wherein the pad picks up selectively the image to be printed, notably from an inked solid surface, i.e. indirect gravure.

40. Method according to one of the claims 30 to 39, characterized in that a circular cliche (3) is inked by rotation about the main axis (l) by means of an ink pot (6) which is fixedly mounted, wherein products (5) and pads (6) are synchronized in rotation about the same reference axis (l) by a physical link, in particular with a rotating disc on the basis of an endless belt in the form of a circular disc (3), in particular wherein the vertical take-up motion by means of a vertical sliding system (8) of the pads (4) is performed by moving a reference point of the pads via a cam system in a cam (9) ridge, wherein both the vertical motion—up-and-down—for the take-up of the image from the cliché and the vertical motion for the deposition of said image on the product is performed during a rotation cycle about the main axis (l), more particularly wherein the products (5) are moved along the reference axis (l) along a circular path that is concentric with the cliché (3), preferably wherein the pad is moved back and forth between said two concentric paths in order to both take-up the image from the cliché and deposit the recorded image on the product with the same pad, wherein for the sake of the preceding horizontal motion (7), a reference point of the pad is moved through a cam system in the cam (9), further wherein the product (5) is placed on said concentric path and removed again within the cycle of one rotation.

41. Method according to one of the claims 30 to 40, characterized in that a cliché (12) is realized as a conveyor belt with the endless belt being in the form of a conveyor belt (19), and it is inked by rotation of the conveyor belt (12) by means of an ink pot (11) which is fixedly mounted, wherein products (18) and pads (14) are synchronized by the action of the gear wheel (15) in the product conveyor belt (19), wherein a reference point of the pads (14) is moved in accordance with a cam system in the cam (16) owing to the vertical motion of the pads during take-up and deposition of the image, wherein during the rotation cycle of the conveyor belt both the vertical motion—up-and-down—for take-up of the image from the cliché (12) and vertical motion for the deposition of the image on the product (18) is carried out, wherein the products (18) are moved along a linear path in parallel with the pads (14), preferably wherein the product (18) is placed outside the deposition area of the image, on the conveyor belt (19) and is removed again therefrom.

42. Method for printing of products via an intermediate carrier, in particular of the pad type, more particularly according to one of the claims 30 to 41, comprising the following steps (Φ₁): inking of the ink carrier, take-up of the ink from the ink carrier, in particular cliché, through an intermediate carrier, in particular the pad, and depositing the ink from the pad onto the product, characterized in that the first phase is the one of inking, wherein the endless belt is inked continuously where depending, the endless and continuous rotary belt continuously inked is via an open or a closed ink system for pad printing, and the images in the belt can be applied as a recess in which the ink is left in the doctoring process, and in predetermined locations on the endless belt to be made, whereby these images by a process to be made outside of the production process being the printing, over the entire length of the belt or restricted to predefined zones for which the tire acts and functions as a temporary carrier on which ink is applied and of which the ink is transferred and recorded to a temporary intermediate support, possibly the product.

43. Method according to the preceding claim, characterized in that in stage (Φ₁), the images are applied by a method which is external to the production process consisting of the printing, or wherein the endless, continuously moving belt is inked continuously through a pad printing open or a closed ink system; wherein the images, which are applied in the belt as a recess in which the ink is left during the doctoring process, are located at predefined locations on the endless belt; wherein these images are applied during the inking and printing manufacturing process with a digital image generation system, or wherein the endless belt is inked through a digital ink system that applies the ink at the predefined locations during the continuous motion of the belt; wherein the belt acts as a support on which ink is temporarily applied and whereof the ink is picked-up and is transferred to a temporary intermediate carrier or possibly even to the product, over the entire length of the belt or limited to predefined zones.

44. Method according to one of the claim 42 or 43, characterized in that after phase (Φ₁), the second phase (Φ₂) is carried out that is the one of ink take-up, wherein the endless belt is continuously inked with images such as in linear printing, after which the linear axis (7a) of a pad is moved in synchronization with the image to be transferred, wherein the pad(s) is/are secured for this purpose to a second endless belt to the first ink carrier synchronization is moved, wherein during this motion the pad is moved according to a linear motion along the axis (7a) whereupon the image is taken up onto the temporary carrier, in particular the pad, whereby during this motion, the relative motion of the pad with respect to the ink carrier is purely linear, on the one hand; wherein in case of rotary printing, the pad is/are then moved in synchronization with the image to be transferred, wherein the pad(s) is/are secured for this purpose to a second endless belt which is moved in synchronization with the first ink carrier, wherein possibly a pad with a developable ruled surface, in particular a cylindrical pad or a segment thereof, is used, in which the speed of the endless belt to which the pad(s) is/are secured is smaller than the doctoring speed of the endless ink carrier, taking into account the relative motion of the pad around its rotational axis transversely to the doctoring direction, or involving the use of a pad which is not a developable ruled surface, wherein the method of ink take-up is analogous to the abovementioned process with traditional linear printing.

45. Method according to one of the three preceding claims, characterized in that after said phase (Φ₁) and (Φ₂), the third phase (Φ₃) is carried out which is the one of the relative positioning of pad respective product, wherein after the image take-up, each pad is being transported along the endless belt which positions the pad in a synchronized way relative to each product which is mounted on a third endless belt, which also takes into account the positioning of the pad with respect to the product in the motion direction of the endless belt to which the products are connected, in the transverse direction thereto and in rotation, in particular because in this 3^{rd} phase (Φ₃) prints in multiple colors are applied on different locations on the product.

46. Method according to the preceding claim, characterized in that after said phases (Φ₁) to (Φ₃), the fourth phase (Φ₄), is carried out that is the one of deposition of ink, wherein in case of linear printing the motion of the endless belts of pads and products are synchronized in such a way that upon motion along axis (7a) the resulting relative motion between the pad and product is linear, whereas in the case of rotary printing, wherein depending on whether a pad with a developable ruled surface, in particular a cylindrical pad or a segment thereof, is used, wherein the speed of the endless belt to which the pad(s) is/are secured is smaller than the speed of the endless belt with the products, taking into account the relative motion of the pad about its rotational axis transverse to the doctoring direction, or a pad is used which is not a developable ruled surface, wherein the method of depositing the ink is analogous to the linear printing process.

47. Method according to one of the claims 41 to 46, characterized in that the cycle according to said phases (Φ₁) operates in parallel for the various pads and products and/or caps, in particular container caps, to be printed by such a method in one or more colors, both at the top surface thereof and at its upright edge.

48. Method according to one of claims 30 to 47, characterized in that when inking through a closed chamber doctor blade system, a set of magnets (A, B) is operated in the doctor blade system, under the action whereof the cliché (G) with magnetic properties is pulled partly to the doctor blade system (B), with reduction of the compressive force on the cliché (G).

49. Method according to one of the claims 30 to 48, characterized in that a double doctor blade (28) is operated with a reduction of the compressive force on the cliché (29).

50. Method according to one of the claims 30 to 49, characterized in that a both integrated and separate system is operated, thereby reducing or removing remnants of ink from the cliché, in order to prevent drying-up or in of ink, including in or on the cliché as an intermediate carrier; in particular by a second doctor blade system, notably with a closed chamber, to be placed after the ink take-up by means of the pad(s), wherein the doctor blade, which is provided with the same ink, or a cleaning agent, notably solvent, fulfills several functions thereby providing in
scraping off ink that is possibly still present and therefore unwanted (wet or dry),
general cleaning of the cliché,
wetting negative image again and/or
moistening any ink residue between the images again.

51. Method according to one of the claims 30 to 50, characterized in that this cleaning process is replaced by and/or further optimized by means of a mechanical action, including through brushing, or via controlled blowing out.

52. Method according to one of the claims 30 to 37, characterized in that the removal of the excess solvent through mechanical action, in particular brushing, is performed by blowing out or even by forced accelerated evaporation, wherein when blowing out or controlled evaporating, the areas between the images are made remainder free for this operation, more particularly by setting an additional doctor blade between cleaning, notably through the doctor blade system with ink or solvent, and blowing out/forced evaporating, notably through an air knife, or by placing the same additional doctor blade prior to a new inking cycle.

53. Method according to one of the claims 30 to 52, characterized in that the viscosity of the ink is kept under control and that the cleaning agent, in particular solvent, is kept clean by operating the circulation systems for ink and/or solvent both to and from the doctor blade systems, yielding a continuous operation of the inking system.

54. Method according to one of the claims 30 to 53, characterized in that said cleaning of the cliché makes the production to be resumed without additional manual operation of a cleaning operator of the cliché, in particular when the production machine goes to standby or even stops, more particularly wherein the stopping of inking is carried out by a controlled stopping of inking when inking is carried out in a digital way, resp. when a doctor blade system with closed chamber is operated, the inking is stopped by moving the doctor blade chamber to an area outside the image area, notably by moving the doctor blade chamber to the center of the cliché, or by moving the doctor blade chamber away from the cliché.
